(19) United States
(12) Patent Application Publication
(10) Pub. No.: US 2012/0211235 A1
(43) Pub. Date: Aug. 23, 2012

(54) CONDUIT ASSEMBLY AND METHOD OF MAKING AND USING SAME

(76) Inventor: David R. Smith, Midland, TX (US)

(21) Appl. No.: 13/398,633

(22) Filed: Feb. 16, 2012

Related U.S. Application Data
(60) Provisional application No. 61/443,617, filed on Feb. 16, 2011.

(51) Int. Cl. E21B 17/01; F16L 55/00; E21B 47/00; E21B 17/00; E21B 23/00; F16L 9/14; B23P 11/00

(52) U.S. Cl. 166/345; 138/140; 138/103; 29/428; 166/242.1; 166/381; 166/254.2

(57) ABSTRACT

The present invention provides conduit assemblies of substantial length that have an inner member disposed in an opening of a conduit member and connected to the interior of the conduit member. The inner member can serve to protect sensitive measuring equipment, such as optical sensors or well logging equipment, from damages, including damages incurred during deployment into subsurface environments, including oil and gas wells and oceans, while allowing for improved data collection by the equipment once deployed. The conduit assemblies can be deployed permanently or as intervention logging equipment. The present disclosure also provides for methods of making and using such conduit assemblies.

### CROSS REFERENCE

The present application claims the benefit of U.S. Provisional Patent Application No. 61/443,617, filed Feb. 16, 2011 and entitled “METHOD AND APPARATUS TO MONITOR SUBTERRANEAN ENVIRONMENTS,” the disclosure of which is incorporated by reference herein in its entirety.

### TECHNICAL FIELD

The present disclosure generally relates to methods and apparatuses for collecting information relating to the subsurface environments, including wellbores and bodies of water. More specifically, the methods and apparatuses allow for improved collection of the information provided by sensors and devices disposed in the subsurface environments.

### BACKGROUND OF THE INVENTION

In conventional systems and methods to monitor subsurface environments, sensors and other electrical devices (e.g., Fabre Perot Sensors, Magneto-Tulleric sensors, seismic geophones and hydrophones, as well as other acoustic, neutron, and electrical generating and receiving packages) are often deployed into subsurface environments encapsulated inside an instrument tube, and/or plastic encapsulation, or other housings. The instrument tube or housing is then either attached to the exterior of the larger conduit or disposed inside a larger conduit unattached for deployment into the subsurface environment. These deployment encapsulation systems are commonly referred to as, Wire Line, Tubing Encapsulated Cable, Control Line, and or Flat Packing by those familiar to the art of oil and gas well completions. In the case of exterior deployed systems, the attachment can be done with bands, clamps, or polymeric coatings. In the case of systems deployed inside conduits such current system encumber the conduit's interior passage to fluids and other well devices like wire line logging or perforating tools, well pumps and rods, plunger lift systems, and other down hole devices known to those familiar with the art of oil and gas production and completion methods.

These conventional arrangements have several disadvantages. For the former conventional arrangement, the instrument tube attached to the exterior of the larger conduit is exposed to the harsh conditions of the subsurface environment. As such, it is prone to being damaged during deployment into wells, particularly in horizontal wells. For the conventional arrangement of deploying the sensors inside a conduit, the instrument tube freely disposed within the larger tube may not provide the most reliable data because it is not coupled to the larger tube and may unnecessarily obstruct the pathway inside the larger tube. Accordingly, there is still a need for methods and apparatuses that protect the sensors and measuring devices as well as provide for improved data collection without unnecessary obstructions.

### BRIEF SUMMARY OF THE INVENTION

According to one aspect of the present disclosure, there is provided a conduit assembly comprising: an inner member having a first end; a second end; and a body between said first end and said second end; and a conduit member having a first end; a second end; a body between said first end and said second end of the conduit member, wherein the conduit member is at least about 30 feet long; and an opening through the body of the conduit member; wherein the inner member is disposed in the opening of the conduit member and attached to the interior surface of the conduit member substantially along the length of the conduit member. In one embodiment, the inner member has substantially the same length as the conduit member. In another embodiment, the inner member is at least about 70% as long as the conduit member.

In one embodiment the inner member is continuously connected to the conduit member. In another embodiment, the inner member comprises an opening through the body of the inner member. In another embodiment, the inner member is adapted to receive at least one measuring device disposed in the opening of the inner member. In one embodiment, the measuring device is selected from the group consisting of optical sensors, including optical fibers, temperature sensors, pressure sensors, acoustic sensors, accelerometers, seismological equipment, and any combination thereof.

In one embodiment, the conduit assembly further comprises at least one electrical wire disposed in the opening of the inner member. In another embodiment, the conduit assembly is configured for deployment into a subsurface environment. In one embodiment, at least one of the conduit member and the conduit of the inner member is configured for production of fluid from the subsurface environment to the surface. In another embodiment, at least one of the conduit member and the conduit of the inner member is configured for injection from the surface to the subsurface environment. In yet another embodiment, the conduit assembly further comprises one or more additional inner members disposed in the opening of the conduit member and connected to the interior of the conduit member substantially along the length of conduit member.

According to another aspect of the present disclosure, there is provided a method of constructing a conduit assembly comprising the steps of: providing a strip of material having a first lateral side, a second lateral side, and a length of at least 30 feet; providing an inner member having a length substantially the same as the strip of material; attaching at least a portion of the inner member to the strip of material along the length of the strip of material; and forming a conduit member with the strip of material subsequent to said inner member being attached to the strip of material by attaching the first and second lateral sides together to form an opening, wherein the inner member is disposed in the opening.

In one embodiment, the attaching comprises welding. In another embodiment, the method further comprises the step of collecting the conduit member onto a reel. In another embodiment, the inner member comprises at least one measuring device disposed in an opening of the inner member. In yet another embodiment, the method further comprises providing at least one additional inner members having a length substantially the same as the strip of material; and attaching at least a portion of the at least one additional inner member to the strip of material along the length of the strip of material prior to said forming step.

According to another aspect of the present disclosure, there is provided a method comprising the steps of: deploying a distal end of a conduit assembly having a length of at least 30 feet into a subsurface environment, said conduit assembly comprising: an inner member comprising: a first end; a second end; and a body between said first end and said second end; and a conduit member comprising: a first end; a second end; a body between said first end and said second end of the conduit member, wherein the conduit member is at least 30 feet long; and an opening through the body of the conduit member; wherein the inner member is disposed in the opening of the conduit member and connected to the interior surface of the conduit member substantially along the length of the conduit member. In one embodiment, the method further comprises the step of collecting data transmitted by at least one measuring device disposed in said conduit assembly. In another embodiment, the measuring device is selected from the group consisting of optical sensors, temperature sensors, pressure sensors, acoustic sensors, accelerometers, seismological equipment, and any combination thereof.

In one embodiment, the deploying step comprises placing the conduit assembly in the subsurface environment permanently to collect information about the subsurface environment over a prolonged period of time. In another embodiment, the method further comprises the step of providing the conduit assembly with energy selected from the group consisting of electrical energy, hydraulic energy, pneumatic energy, and any combination thereof. In another embodiment, the method further comprises the step of producing fluid through the conduit assembly from said subsurface environment to the surface. In another embodiment, the method further comprises the step of injecting fluid through the conduit assembly from the surface to said subsurface environment. In yet another embodiment, the method further comprises the step of equipping the distal end of the conduit assembly with at least one device selected from the group consisting of mechanical device, electrical device, magnetic device, telluric device, acoustical device, neutron generating device, and any combination thereof.

In one embodiment, the subsurface environment comprises a body of water. In another embodiment, the method further comprises the step of: providing a vessel, wherein a proximal end of the conduit assembly is attached to the vessel. In another embodiment, the method further comprises monitoring the subsurface environment using at least the collected data. In yet another embodiment, the method further comprises moving the conduit assembly through the subsurface environment while collecting information about the subsurface environment.

### BRIEF DESCRIPTION OF THE DRAWINGS

For a more complete understanding of the present invention, reference is now made to the following descriptions taken in conjunction with the accompanying drawing, in which:

FIG. 1A is a cross section of an exemplary conduit assembly of the present disclosure;

FIG. 1B is a magnified view of a portion of the exemplary conduit assembly of FIG. 1A;

FIG. 2 illustrates an exemplary conduit assembly of the present disclosure deployed in a horizontal well; and

FIG. 3 illustrates an exemplary process to make the conduit assembly according to the aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. Also, for simplification purposes, there may be only one exemplary instance, rather than all, is labeled. It should be understood, of course, that this disclosure is not limited to the particular embodiments illustrated herein.

### DETAILED DESCRIPTION OF THE INVENTION

As described herein the term “surface” can include a position located at the proximal end of the conduit assembly and can be the surface of the earth, surface of a body of water, a location on a surface water vessel, or a location on a submerged vessel. The present disclosure provides conduit assemblies that protect sensitive measuring equipment, such as sensors, wires, optical fibers, and power storage and transmission devices, from damages during deployment into a subsurface environment while allowing for improved data transmission and collection by the equipment once deployed. The present disclosure also provides for methods of making such conduit assemblies. The conduit assemblies of the present disclosure are particularly suited horizontal wells, where a portion of a well bore is constructed horizontally through the earth. The conduit assemblies of the present disclosure are also suited for subsurface environments having a body of water, such as oceans, and in the fields of reflection seismology, magnetotellurics, and optical time domain reflectometry for temperature and acoustic monitoring.

According to one aspect of the present disclosure, the conduit assembly has a small conduit disposed within and connected to the interior surface of a large conduit along the length of both conduits. The conduits can be continuously or discontinuously connected along the length of both conduits. The smaller conduit is preferably welded to the interior surface of the larger conduit. According to another aspect of the present disclosure, there is a method to make the conduit assembly by attaching the small conduit during the manufacturing of the large conduit. In one embodiment, the large conduit is made from sheet metal strip. The small conduit is attached to the sheet metal strip prior to the sheet metal strip being formed into the large conduit. Once attached, the lateral sides of the sheet metal strip can be connected to form the large conduit with the connected small conduit disposed inside.

In one embodiment, the conduit assemblies of the present disclosure is moved through the subsurface environment while data is collected for the purpose of monitoring the subsurface environment. In another embodiment, the conduit assemblies of the present disclosure can be attached to a water going vessel such as a ship or submarine for the purpose of monitoring subsurface environments. The water going vessel can be moving or stationary.

In another embodiment, the conduit assemblies can be deployed permanently or as intervention logging equipment. For those familiar with the art monitoring subsurface environments, particularly underwater environments, using monitoring systems composed of sensors, arrays of sensors, logging tools, transmitters, and receivers, these monitoring systems are generally deployed in two general deployment classes. The first class is the “intervention” deployment where the sensors and devices, which can be disposed in wire rope or a conduit assembly according to the aspects of the present disclosure, are deployed temporarily, typically less than several hours at any one subsurface position. The sensors and the deployment mechanism are then retrieved from the subsurface environment onto a ship, a logging truck, or a submarine for subsequent deployment elsewhere or storage.

In the second class of deployment the sensors, arrays of sensors, and measuring devices are deployed “permanently” into the subsurface environment and they remain there permanently with the proximal end of the array connected to a surface monitoring station. This permanent deployment often results in the monitoring system deployed in an ocean, on an ocean bed, or in a well bore, often times by grouting for weeks, months, or even years, to collect data and information over a prolonged period of time. The systems may be retrieved from the permanent deployment for repair or recover of the system. The conduit assemblies of the present disclosure can be deployed in a subsurface environment for a prolonged or extended period of time such as days to weeks and can be retrieved eventually as appropriate. Permanent deployment allows for long term monitoring of acoustic, seismic, telluric changes, thereby giving a fourth dimension to the monitoring system of time, wherein the changes in the earth's properties can be monitored. For example, in the field of magnetotellurics the resistivity of the earth can be monitored over time to look for the movement of hydrocarbons and enhanced oil recovery fluids.

In yet another embodiment, the conduit assemblies of the present disclosure is of substantial length, preferably at least 30 feet, and typically from at least 100 feet to over 1000 feet, preferably at least 500 feet long. While the present disclosure describes deployment of the conduit assemblies of present disclosure in a subsurface environment, such as a oil and gas well or body of water, including ocean, the conduit assemblies can be used in other applicable environments.

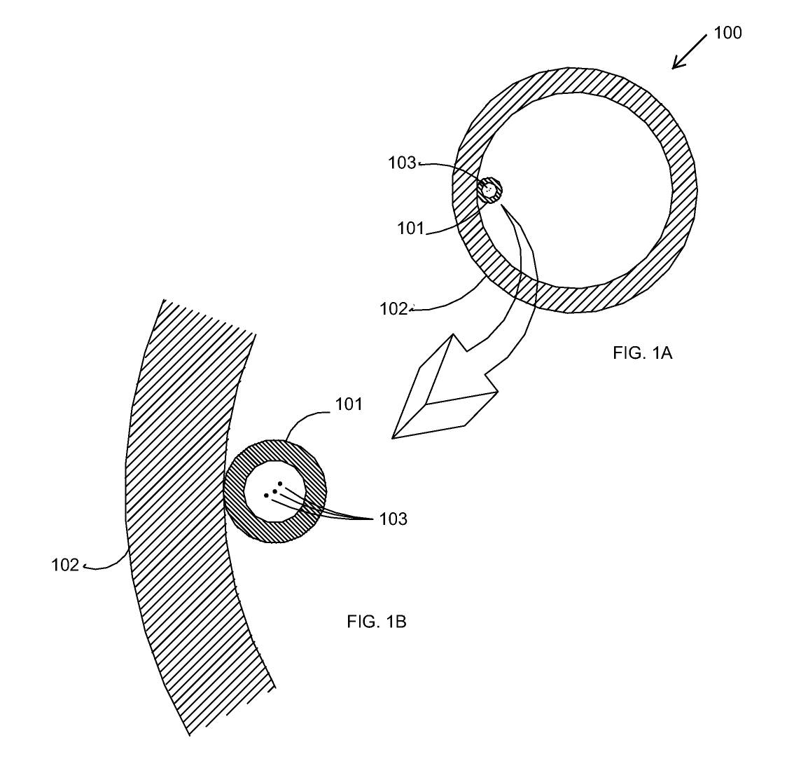

In an exemplary embodiment, reference is made to FIG. 1, which shows a cross section of conduit assembly 100. Conduit assembly 100 has inner member 101 that is attached to the internal surface of conduit member 102. Conduit member 102 is preferably at least about 30 feet long, more preferably between 100 feet to over 1000 feet, and most preferably 500 feet long. In a preferred embodiment, inner member 101 has substantially the same length as conduit member 102. In another embodiment, inner member 101 is at least about 70% as long as conduit member 102, more preferably about 70% to 90% as long as conduit member 102. Inner member 101 has an opening through its body configured to receive measuring equipment 103, such as sensors. As shown in FIGS. 1A and 1B, measuring devices 103 are disposed within inner member 101. Measuring devices 103 can include sensors, such as optical fibers, electrical wires, accelerometers, geophones, hydrophones, microphones, electromagnetic receivers and transmitters, neutron transmitters and receivers, acoustic transmitters and receivers, and other devices well known to those in the field of well logging. The measuring device can also comprise optical sensors, temperature sensors, pressure sensors, acoustic sensors, accelerometers, seismological equipment, and any combination thereof.

In the preferred embodiment, inner member 101 is welded to conduit member 102 along the length of both conduits. The welding can be continuous or just portions of inner member 101 are welded to conduit member 102 along the length of conduit member 102. In other embodiments, conduits 101 can be attached to conduit member 102 through other means known to those skilled in the art. In one embodiment, conduit member 102 is a coiled tubing used in oil and gas wells. The data collected can include velocity and acceleration of the subsurface environment, as well as acoustic, temperature, and magnetic changes in the subsurface environment.

In another embodiment, inner member 101 is a solid member which serves as a guide mechanism for devices and fluid being deployed or flowed through the conduit assembly 100. In this or other embodiments, one or more measuring devices can be disposed in conduit member 102. In yet another embodiment, conduit assembly 100 has more than one inner member 101, where one inner member 101 can be a conduit with an opening as shown in FIGS. 1A and 1B and another inner member can be a solid member serving as a guide, such as a key way or rail.

Conduit assembly 100 allows a substantial portion of the interior of conduit member 102 to be available, e.g., substantially unobstructed, to accommodate the passage of other devices such as logging devices, plugs, packers, guns with explosive charges, without damaging sensitive measuring devices 103 disposed inside inner member 101. Inner member 101 and conduit member 102 can be made of any material appropriate for the subsurface environment into which conduit assembly 100 is deployed.

In the preferred embodiment, inner member 101 and conduit member 102 are tubular in shape. In other embodiments, other geometrical forms of rods, tubes, and wire can be used including electrical rods, wire rope, perforated tubes, square tubes, other any other geometrical shapes, and any combination thereof.

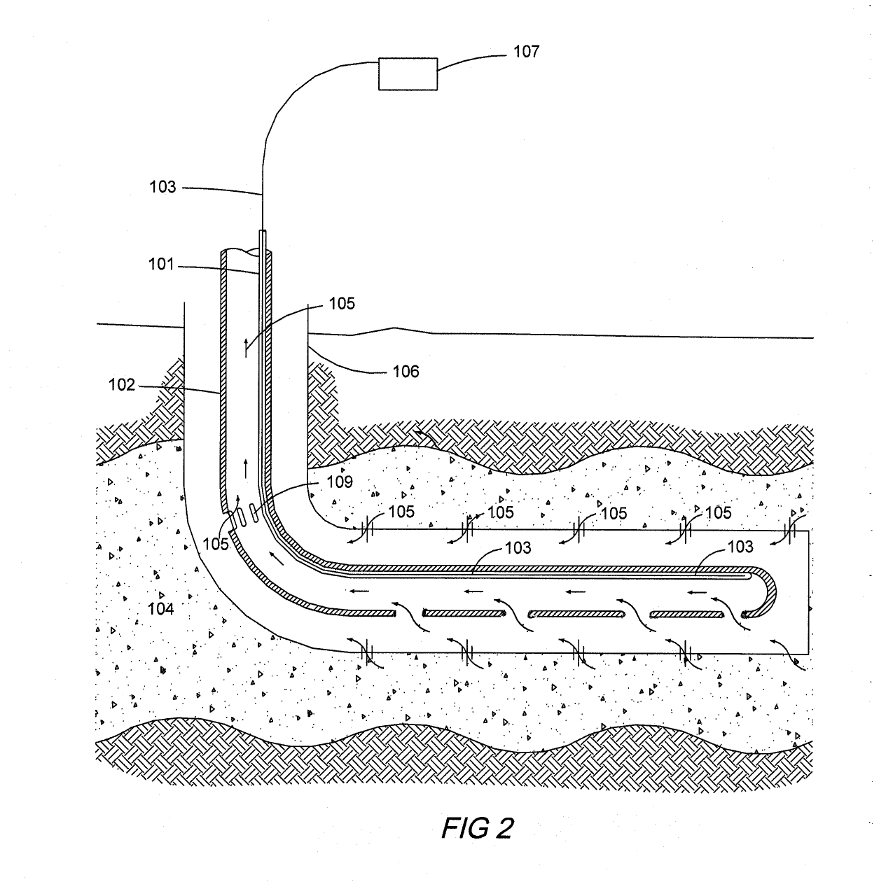

Referring to FIG. 2, conduit assembly 100 is deployed in a horizontal well 206. Measuring devices 103 are disposed inside inner member 101 and are protected from damages during deployment of conduit assembly 100. In certain embodiments, conduit member 102 can include one or more production ports 109, which allow reservoir fluids 105 to flow from reservoir 104 to the surface. Once deployed, conduit member 102 becomes an acoustical diaphragm and the acoustic energy of subsurface environment 104, such as vibration, is transmitted to conduit member 102 and collected by measuring devices 103. The coupling of measuring devices 103 to conduit member 102 through the attachment of inner member 101 improves the data, such as acoustic energy and temperature, collected by measuring devices 103. The opening of inner member 101 or the opening of conduit member 102 can be filled with a fluid to enhance the transmission of the data from the subsurface environment measuring devices 103. Either inner member 101 or conduit member 102 can allow for production of fluid from subsurface environment 104 to the surface or injection of fluid from the surface to subsurface environment 104.

Referring to FIG. 2, measuring devices 103 is connected to data processing device 107, which collects and analyzes the data to allow for monitoring of conditions of the subsurface environment. In one embodiment, measuring devices 103 include one or more optical fiber sensors and data processing device 107 employs Optical Time Domain Reflectometry (OTDR) and interpretive algorithms to process the collected data. In one embodiment, data processing device 107 includes OTDR machines for launching light down the optical fiber(s), recording the information from the optical fiber(s), and analyzing the collected information.

In other embodiments, conduit assembly 100 can be deployed from a vessel through a body of water, where data processing device 107 is located on the vessel. The vessel that can be moved through or supported by a body of water, including surface going ships, submarines, and buoys. The vessels can be moving or stationary.

In other embodiments, conduit assembly 100 can be further equipped with mechanical devices, electrical devices, magnetic devices, telluric devices, acoustical devices, neutron generating devices, neutron capture devices, and any combination thereof. In particular, one or more of these devices can be connected to the distal end of conduit member 102. Electrical, hydraulic, and/or pneumatic power can be transmitted through conduit assembly 100.

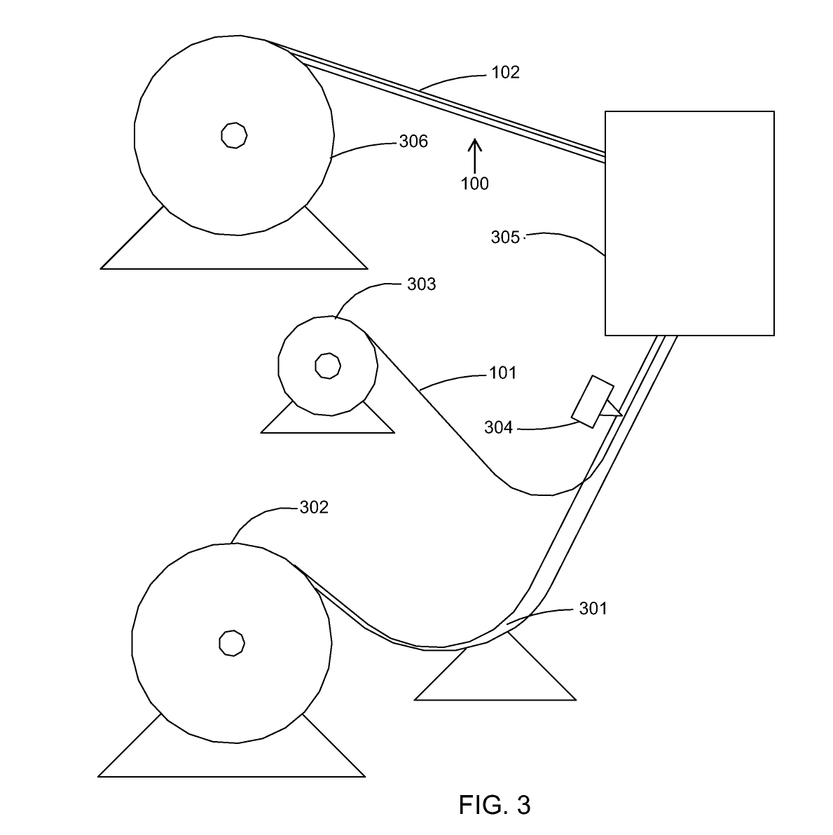

According to another aspect of the present disclosure, there are methods to make the conduit assemblies of the present disclosure. Referring to FIG. 3, material 301 is dispensed from reel 302. In one embodiment, material 301 comprises any type of metals and alloys thereof, including ceramic metal alloys. Material 301 is preferably in the form of a sheet strip. In the preferred embodiment, material 301 comprises steel. Inner member 101 is dispensed from reel 303 and is attached to material 301 by welder 304 prior to being fed into mill 305. One or more reels 303 and corresponding number of welder 304 can be provided to attach additional inner members 101 to material 301 to provide a conduit assembly with more than one inner member 101. As shown, inner member 101 is continuously welded to material 301 along its length prior to entering mill 305. However, in other embodiments, inner member 101 can be intermittently welded to material 301 along its length prior to entering mill 305.

Once attached, both inner member 101 and material 301 enter mill 305 where material 301 is formed into conduit member 102. In one embodiment, mill 305 brings the lateral sides of material 301 together in the desired shape and welds the sides together. In one embodiment, conduit assembly 100 can be collected on reel 306 for subsequent use, such as to be equipped with measuring devices for deployment in a subsurface environment, such as a well site or coiled conduit injection truck for field deployment or placed on a water going vessel where the conduit assembly 100 is spooled off reel 306 into a subsurface environment. As mentioned above, inner member 101 can have any geometrical shape and a plurality of inner members 101 can be disposed in conduit member 102.

As described, the present disclosure provides methods and apparatuses that protect the sensors and measuring devices as well as provide for improved data collection without unnecessary obstructions. In addition, the present disclosure provides for conduit assemblies with a “smooth” exterior surface that allows for the use of with common hydraulic pack off means, which can be problematic for systems where the encapsulated sensors are attached to the outside of the conduit because they can be prone to leaking, thereby requiring more maintenance. In addition, the conduit assemblies of the present disclosure can be deployed from buoys and trailed behind submarines or surface water vessels as monitoring arrays. In addition, certain embodiments utilizing gas in the conduit assemblies can provide control of the buoyancy of the conduit assemblies in use.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A conduit assembly comprising:
an inner member comprising:
a first end;
a second end; and
a body between said first end and said second end; and
a conduit member comprising:
a first end;
a second end;
a body between said first end and said second end of the conduit member, wherein the conduit member is at least about 30 feet long; and
an opening through the body of the conduit member;
wherein the inner member is disposed in the opening of the conduit member and connected to the interior surface of the conduit member along at least a portion of the length of the conduit member.

2. The conduit assembly of claim 1 wherein the inner member has substantially the same length as the conduit member.

3. The conduit assembly of claim 1 wherein the inner member is at least about 70% as long as the conduit member.

4. The conduit assembly of claim 1 wherein the inner member is continuously connected to the conduit member.

5. The conduit assembly of claim 1 wherein the inner member comprises an opening through the body of the inner member.

6. The conduit assembly of claim 5 wherein the inner member is adapted to receive at least one measuring device disposed in the opening of the inner member.

7. The conduit assembly of claim 6 wherein said measuring device is selected from the group consisting of optical sensors, temperature sensors, pressure sensors, acoustic sensors, accelerometers, seismological equipment, and any combination thereof.

8. The conduit assembly of claim 5 further comprising at least one electrical wire disposed in the opening of the inner member.

9. The conduit assembly of claim 1 wherein the conduit assembly is configured for deployment into a subsurface environment.

10. The conduit assembly of claim 9 wherein at least one of the conduit member and the conduit of the inner member is configured for production of fluid from the subsurface environment to the surface.

11. The conduit assembly of claim 9 wherein at least one of the conduit member and the conduit of the inner member is configured for injection from the surface to the subsurface environment.

12. The conduit assembly of claim 1 further comprising at least one additional inner member disposed in the opening of the conduit member and connected to the interior of the conduit member along at least a portion of the length of conduit member.

13. A method of constructing a conduit assembly comprising the steps of
providing a strip of material having a first lateral side, a second lateral side, and a length of at least about 30 feet;
providing an inner member having a length substantially the same as the strip of material;
attaching at least a portion of the inner member to the strip of material along the length of the strip of material; and
forming a conduit member with the strip of material subsequent to said inner member being attached to the strip of material by attaching the first and second lateral sides together to form an opening, wherein the inner member is disposed in the opening of the formed conduit member.

14. The method of claim 13 wherein said attaching comprises welding.

15. The method of claim 13 further comprising the step of collecting the conduit member onto a reel.

16. The method of claim 13 wherein the inner member comprises at least one measuring device disposed in an opening of the inner member.

17. The method of claim 13 further comprising:
providing at least one additional inner members having a length substantially the same as the strip of material; and
attaching at least a portion of the at least one additional inner member to the strip of material along the length of the strip of material prior to said forming step.

18. A method comprising the steps of:
deploying a distal end of a conduit assembly into a subsurface environment, said conduit assembly comprising:
an inner member comprising: a first end; a second end; a body between said first end and said second end, and
a conduit member comprising: a first end; a second end; a body between said first end and said second end of the conduit member, wherein the conduit member is at least about 30 feet long; and an opening through the body of the conduit member; and
wherein the inner member is disposed in the opening of the conduit member and connected to the interior surface of the conduit member substantially along the length of the conduit member.

19. The method of claim 18 further comprising the step of collecting data transmitted by at least one measuring device disposed in said conduit assembly.

20. The method of claim 19 wherein said at least one measuring device is disposed in an opening through the body of the inner member.

21. The method of claim 19 wherein said at least one measuring device is selected from the group consisting of optical sensors, temperature sensors, pressure sensors, acoustic sensors, accelerometers, seismological equipment, and any combination thereof.

22. The method of claim 19 further comprising
monitoring the subsurface environment using at least the collected data.

23. The method of claim 19 further comprising the step of
moving the conduit assembly through the subsurface environment while collecting information about the subsurface environment.

24. The method of claim 19 wherein the deploying step comprises placing the conduit assembly in the subsurface environment permanently to collect information about the subsurface environment over a prolonged period of time.

25. The method of claim 18 further comprising the step of providing the conduit assembly with energy selected from the group consisting of electrical energy, hydraulic energy, pneumatic energy, and any combination thereof.

26. The method of claim 18 further comprising the step of
producing fluid through the conduit assembly from said subsurface environment to the surface.

27. The method of claim 18 further comprising the step of
injecting fluid through the conduit assembly from the surface to said subsurface environment.

28. The method of claim 18 further comprising the steps of:
equipping the distal end of the conduit assembly with at least one device selected from the group consisting of mechanical device, electrical device, magnetic device, telluric device, acoustical device, neutron generating device, and any combination thereof.

29. The method of claim 18 wherein the subsurface environment comprises a body of water.

30. The method of claim 29 further comprising the step of:
providing a water going vessel, wherein a proximal end of the conduit assembly is attached to the water going vessel.
